(19) United States
(12) Patent Application Publication
(10) Pub. No.: US 2025/0229639 A1
(43) Pub. Date: Jul. 17, 2025

(54) Self-Charger for Electric Vehicles

(71) Applicants: Moh Altamimi, Palisades Park, NJ (US); Steve Williams, Palisades Park, NJ (US)

(72) Inventors: Moh Altamimi, Palisades Park, NJ (US); Steve Williams, Palisades Park, NJ (US)

(21) Appl. No.: 18/982,984

(22) Filed: Dec. 16, 2024

Related U.S. Application Data
(60) Provisional application No. 63/621,019, filed on Jan. 15, 2024.

(51) Int. Cl. B60L 8/00; B60L 53/52

(52) U.S. Cl. CPC B60L 8/006; B60L 53/52

(57) ABSTRACT

A Smart Electric Vehicle (SEV) which works by free clean energy provided it by Smart Wind Generator (SWG) which depends completely on wind energy, with using a small fan, to produce the wanted power under the impact of the wind speed power as the opposite power of Electric Vehicle Speed (EVS) on the road, to keep Electric Vehicle's Batteries (EVBs), on a good charging, without needing of electric grid. This SWG is configured to be a small generator (about 3.5 kg) with light and small fan, to generate the wanted power as a self-charger for SEV. This SWG is never used as an assistant charger, but it is the entire tool that will be used to convert the old system of charging electric vehicle to a self-charging system. Also, this invention is very simple, very easy to manufacture and to install in the SEVs, as a self-charger.

### PRIORITY CLAIM

This application claims priority to provisional patent No. 63/621,019, filing date 01/15/2024.

### FIELD OF THE INVENTION

The present invention relates generally to generators and charging electric vehicles while driving. Particularly, the present invention is a smart wind generator that charges one of electric vehicle's batteries while driving as needed depending completely on wind energy.

### BACKGROUND OF THE INVENTION

Charging is one of the largest concerns of operating an electric vehicle. Current electric vehicles may not have the capacity to drive distances as far as needed. During long drives, an electric vehicle must stop at a charging station to recharge battery. Unlike visits to gas stations, drivers of electric vehicles (EVs) may spend half an hour or more waiting to charge sufficiently before continuing. In addition to adding to total trip duration, the frequent need to stop at charging stations can be stressful and dangerous to drivers in areas where charging stations are scarce. Electric vehicle drivers fear running out of battery and being stranded without any ability to recharge. As a result, there is an urgent need for a self-charging system, for electric vehicles, in order to extend their driving range, as longest as needed.

Currently, charging electric vehicles by using solar power is available. However, one main drawback of using solar power is that solar power becomes ineffective after sunset, at night, or even when the sky is cloudy. As a result, solar power is a limited option for recharging electric vehicles and can be uncomfortable and unreliable for drivers.

Also, the portable or the mobile generators that depend on gas or additional battery, are not satisfied for users of EVs. It is the same issue with the wireless charging or autonomous robots. The hardest obstacles standing in front of these technologies is not just the construction of the required grid infrastructure for the process of recharging EVs on the roads, but it will be in the capacity of US electric grid. An estimation indicate that this capacity is less than meeting the needs of recharging the EVs, if all cars in USA become EVs.

Farther, using the wind power as a partial option to help charging the battery of EV is not as effective as what is to be accomplished according to the present invention.

For the first time, there is an opportunity for drivers, to drive their Electric Vehicles (EVs) with no need to stop anywhere for the purposes of recharging.

### SUMMARY OF THE INVENTION

Clean energy is the best choice (now and later) to keep our environment clean and our planet more shining. For that, this self-charger disclosed in the present invention, for any EV that moves on routes, is working good with full free clean energy.

One of the objectives of the present invention is to provide an effective alternative to solar-powered and gas-powered mobile generators for charging electric vehicles. The present invention is a smart wind generator that charges electric vehicles while driving depending on wind energy.

Another objective of the present invention is to embrace clean energy. Using renewable energy helps keep the environment and the planet clean. It is important to innovate new forms of clean energy such as electric vehicles and the present invention itself to accomplish this objective. The present invention seeks to increase daily use of clean energy; reduce carbon emissions as much as possible; help others in resolving the climate change crisis as much as possible; help make the United States of America to be a top leader in renewable energy; help American people to reduce their energy bills; and reduce the global energy bill in the world. Due to these objectives, we had multiple experiments to prove that the present invention is qualified.

Our first experiment was about the speed of wind, where we wondered how this uncontrollable wind speed can be converted to a controllable speed, by using the speed of EV on the roads, to increase the rotations of the drive shaft of wind generator (WG) by using a small fan.

By proceeding this first experiment, we discovered that the wind speed could be put under full control. For the purpose of this experiment, initially we had used a digital anemometer device to get an initial experience about the control method of wind speed, where we successfully used the speed of EV on the roads, to increase the rotational speed of the small fan of WG, where we got a 15-37 meter per second (37 m/s) of wind speed, by applying a 25-55 miles/hour (25-55 mph) of EV's speed, which finally means that we can develop any suitable WG by installing a small fan on its drive shaft, to be a Smart Wind Generatror (SWG), to produce the wanted power under the impact of EV's speed.

By this experiment, we noted that the wind speed is directly proportional to the speed of vehicle on the road, which means that we can increase the rotational speed of fan of SWG; where this experiment resulted that, we can use a small WG with small fan, to produce the wanted power as needed for recharging any empty battery of EV while driving, which encourages us to run a small WG with small fan to be a SWG with the following specifications:
1. three isolated phases;
2. The current output is Alternating Current (AC);
3. The power of this generator is 220 volts and 10 KWh;
4. The total weight of SWG is 3.5 kg;
5. The diameter of the WG is 15 cm;
6. The diameter of the small fan is 48 cm, with 10 blades (see FIG. 1).

In conclusion, SWG according to the present invention, will need to develope EV to be a Smart Electric Vehicle (SEV) which will work by free clean energy with two separated units of batteries and a smart sensor which works as an automatic switchable power connector.

Other experiments had been done by us on the roads, proved that the present invention begin generated the wanted power when vehicle speed becomes 30 mph, wherein the small fan gets a 18 m/s wind speed, also these experiments proved that SWG couldn't generate the wanted power when the vehicle's speed being less than 30 mph or more than 55 mph, despite the rotating of small fan and drive shaft. Also, it is proved by these experiments that the fan and drive shaft of SWG is stopping rotating when the vehicle's speed being more than 60 mph.

### BRIEF DESCRIPTION OF THE DRAWINGS

FIG. 1 is a schematic view of the SWG according to one embodiment of the present invention, the SWG comprises a WG with four screws and drive shaft, a small fan, and a base.

FIG. 2 is a schematic view of the self-charging system, the system comprising a SWG, a smart sensor, two switchable charging connectors, two separated units of EV batteries, and a motor.

FIG. 3 is a sketch of virtual trip displaying a relationship between the charging and discharging power of Electric Vehicle batteries (EVBs) while driving, to prove the effectiveness of SWG.

### DETAILED DESCRIPTION OF THE INVENTION

All illustrations of the drawings are for the purpose of describing selected embodiments according to the present invention and are not intended to limit the scope of the present invention.

The present invention is a SWG that charges (EVBs) as needed, depending completely on the wind energy, by using the impact of the electric vehicle's speed to increase the rotational speed of the small fan according to the embodiment of the present invention, SWG is able to convert wind energy to electric energy. While driving, wind speed is directly proportional to the speed of the vehicle. By accelerating and increasing vehicle speed, rotational speed of the small fan will be automatically increased. The present invention uses a small wind generator with a small fan to produce the wanted power for charging EVBs as needed, while driving.

SWG which is developed to be a self-charger, comprises a small WG with four screws, a drive shaft, a small fan, and base, according to the embodiment of the present invention. Self-charger can output three isolated AC phases. Self-charger outputs in alternating current (AC). In the preferred embodiment of the present invention, the power of the self-charger is 220 volts and 10 KW. Said self-charger in the embodiment weighs 3.5 kg including the drive shaft, the base and the small fan. In said embodiment, the WG of self-charger has a diameter of 15 cm. In said embodiment, the small fan has diameter is 48 cm, the small fan has 10 blades. The drive shaft needs at least 600 Revolutions Per Minute (600 RPM) to produce 220 volts, 10 KW, and 45.45 Amp.

According to the following equation, the wind speed (V) and the air swept area (A) which depends on the radius of the fan (R=24 cm) are very important, where the Tip Speed Ratio (TSR) is a factor (it's 3.5 for this SWG), and 6.28 is a physical constant:

$$RPM = \frac{v \times TSR \times 60 seconds}{6.28 \times A}$$

The following formula proves that it is easy for SWG to get the wanted RPM with lower wind speed (18 m/s) which comes by medium speed of vehicle (30 mph):

$$RPM = \frac{18 m / s \times 3.5 \times 60 seconds}{6.28 \times 0.1 \; 81 m} = 2506$$

Accordingly, the resulting 2506 RPM is sufficiently good to generate the power. But for the purpose of generating a suitable power, there are different values, factors and quantities impact on the generator power (P), like; (v) wind speed in m/s, (C_{P}) power coefficient which is percentage factor (0.48), (p) air density which is 1.225 kg/m³ in average, (A) swept fan area in m² which is given by this equation: (A=πTR²), (R) fan radius in meter, and (η) generator efficiency which is about 53-75% as defined scientifically.

So, the generator power (P) is given by the following equation:

$$P = 0.5 ( {c}_{p} ) ( P ) ( A ) ( {V}^{3} ) η$$

In the present invention, the wanted power is generated even when we have the lower wind speed (18 m/s) and the minimum rate of efficiency (53%):

$$P = 0.5 ( 0.48 ) ( 1.225 ) ( 0.181 ) ( {18}^{3} ) 53 \% = \frac{164.48 watt}{second} = 9.87 kw / minute$$

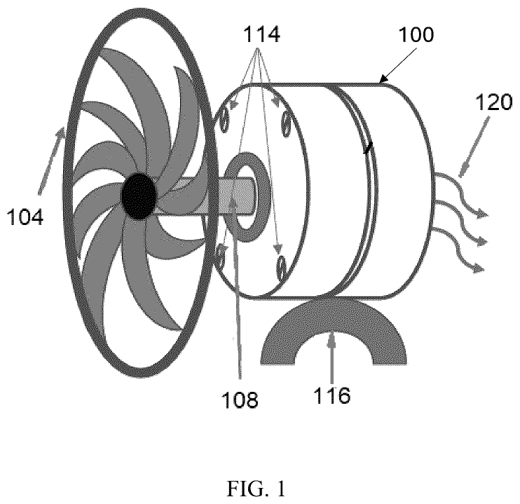

Referring to FIG. 1, there illustrated is a schematic view of the SWG according to one embodiment of the present invention. The SWG functions as a self-charger. The SWG according to the embodiment of the present invention can output three isolated alternating current (AC) phases 120.

In the preferred embodiment of the present invention, the power of the SWG is 220 volts and 10 KW. Said embodiment the weighs of SWG is 3.5 kg including the drive shaft, the base and the small fan. In said embodiment, the WG has a diameter of 15 cm. In said embodiment, the small fan has a diameter of 48 cm with 10 blades. The drive shaft needs at least 600 Revolutions Per Minute (600 RPM) to produce 220 volts, 10 KW, and 45.45 Amp.

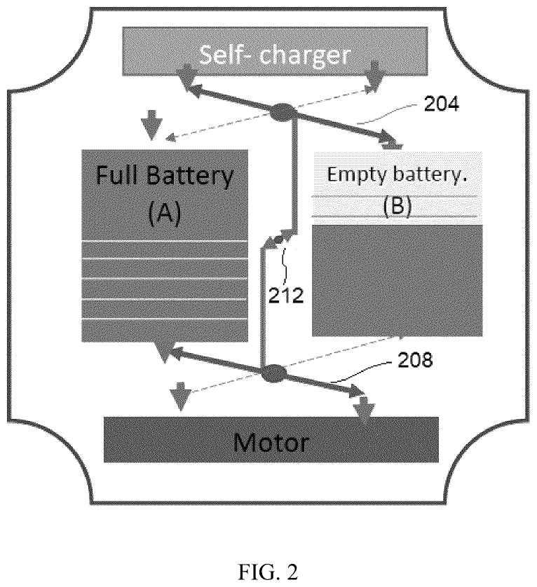

Referring to FIG. 2, there illustrated is a schematic view of the self-charging system. The system comprises a SWG, two unites of Electric Vehicle Batteries (EVBs) including one battery (A) for powering the motor of SEV, when it is a good charged Battery and the other battery (B) for getting a power from SWG, when it is an Empty battery, a motor which used to run and move the SEV, a switchable charging connector 204, and a switchable charging connector 208, a smart sensor 212 which works as an automatic switchable power connector, to connect the self-charger with empty battery (B) and disconnect it with full battery (A) by the switchable charging connector 204, in the same time, the smart sensor 212, will connect the full battery (A) with motor and disconnect the motor with empty battery (B) by the switchable charging connector 208. This process is a switchable automatically by the smart sensor 212, when the battery (A) becomes empty and battery (B) becomes full charged.

According to the theoretical and physical descriptions, and the drawing of this invention, it is easy technically to use SWG in any SEV by putting it in the front part of it or on the top of it, to let the small fan receives the wind as easy as should be, and then when SEV moves on the road, the fan will get start rotating under the impact of wind power which coming by the impact of SEV's speed, and by the way, the fan rotates the drive shaft of WG, then the wind speed will be accelerated by increasing the speed of SEV (under the impacting of the Newton's third law; (F₁₂=F₂₁) and by the way, the rotation speed of the small fan will be accelerated too, which means, the acceleration of drive shaft of the WG will be the same. By this way, this SWG will generate the wanted power as a self-charger for any empty battery of SEV, or any empty battery of other moving vehicles; like electric buses, electric trains . . . etc.

To avoid getting the charging and discharging (powering) precesses in same time, because it causes a high temperatures in batteries and other issues, it is recommended to use the present invention with two separated units of (EVBs) and a smart sensor 212, as described in FIG. 2.

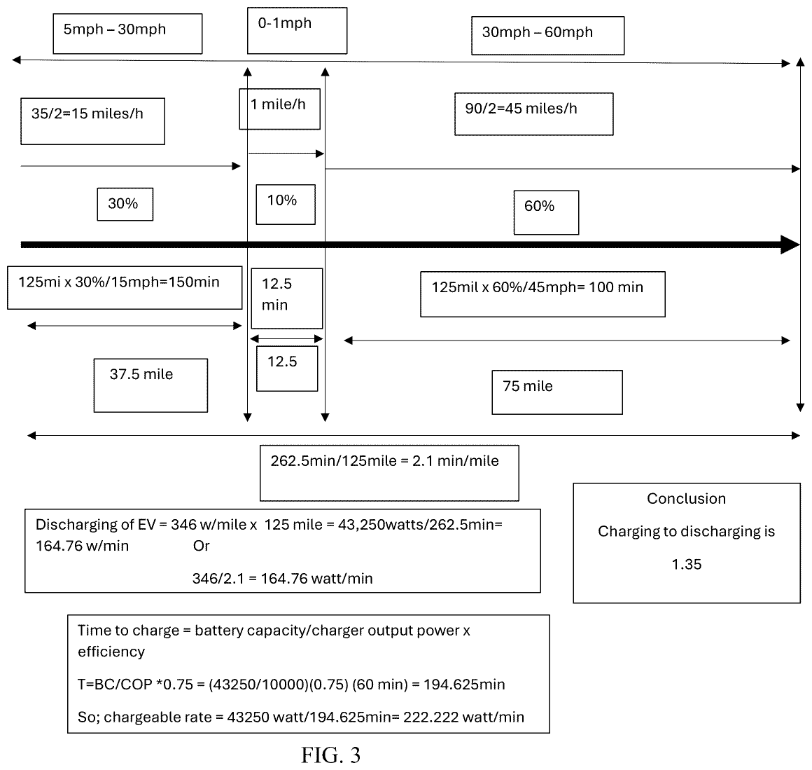

Referring to FIG. 3, there illustrated is a sketch of virtual trip displaying the relationship between the charging power of SWG and discharging power of battery. For discharging process, it is known that any EV needs 346 watt/mile, to drive it on the roads. As shown in FIG. 3, to prove the effectiveness of the SWG, let us assume that SEV has a long trip (125 miles). In this case we assume that one of two batteries of SEV is fully charged and the other is empty. We also assume that 30% of this trip will be in traffic or local streets where the speed of SEV will be 5-30 mph, 10% of this trip will be on stop signs or red lights (0 mph) and the rest of this trip will be on highways where the speed of SEV will be 30-60 mph. in this case, it is easy to find that one mile, in average, needs about two minutes driving. So, this long trip will take 262.5 minutes to be completed (262.5 min/125 mil=2.1 minutes/mile). In this case, it is easy to find that SEV will need 43.25 kw to complete this trip (125 mil×346 watts=43250 watts). in case of calculating the discharging rate, we find (43.25 kw/262.5 min=164.76 w/min). It is the same when we say ((346 w/2.1 min=164.76 w/min) because one mile driving needs 2.1 minutes, in average.

The following formula calculates the time for charging the battery:

$$Time to charge ( T ) = battery capacity / charger output power \times efficiency \times 60 min$$

$$T = ( 43250 / 10000 ) ( 0.75 ) ( 60 min . ) = 194.625 min .$$

$$Charging rate = 43250 watt / 194.625 min . = 222.22 watt / min$$

In all of the calculations shown in FIG. 3, it is concluded that the charging to discharging rate of SWG is 1.35, which is so satisfied to keep one battery of SEV in a well charged state. In meaning, this rate is very important to keep one of these two batteries in a well charged state, because while the powering process needs 262.5 minutes to discharge battery (A) in this trip, the charging process of battery (B) needs 194.625 minutes, which means that the charging process is faster than discharging. That is because the chargeable rate of this SWG is 222.22 watt/minute, but the dischargeable rate of any battery is 164.76 watt/minute. So, if you divide 222.22/164.76 you will get the rate of charging to discharging (which is 1.35). But if you deduct 10% of the time of this trip as this SWG is not productive when the speed of SEV less than 10 mph, you will find that this vehicle spent the same amount of power (43.25 kw) while this SWG had generated 55.555 kw, which means this rate still active (1.28) and SWG still productive.

Although the invention has been explained in relation to its preferred embodiment, it is to be understood that many other possible modifications and variations can be made without departing from the spirit and scope of the invention.

What is claimed is:

1. A self-charging system for SEV, the self-charging system comprising a SWG, two separated units of (EVBs), a smart sensor, two switchable charging connectors and motor of SEV, wherein the SWG includes a WG, and fan, wherein the WG includes a drive shaft, a base supporting the wind generator, and four screws fixing the WG with its cover, the drive shaft being rotated by the fan under the impact of wind power which is getting as the opposite force of SEV's speed, wherein EVBs include one unit for powering the motor of SEV when this battery is fully charged, and the other unit of EVBs will be in case of recharging by SWG as needed, and wherein the smart sensor is an automatic switchable power connector, to switch the power as needed between SWG, EVBs and the motor of SEV by using the switchable charging connectors, to avoid getting the recharging and powering processes in same time.

2. The self-charging system of claim 1, wherein the fan comprises 10 blades.

3. The self-charging system of claim 1, wherein the diameter of the blades is 48 cm.

4. The self-charging system of claim 1, wherein the wind generator outputs three isolated AC phases.

5. The self-charging system of claim 1, wherein the wind generator is located in the front of the EV.

6. The self-charging system of claim 1, wherein the wind generator is located on the top of the EV.
